(19) United States
(12) Patent Application Publication
(10) Pub. No.: US 2022/0044335 A1
(43) Pub. Date: Feb. 10, 2022

(54) FRIEND RECOMMENDATION METHOD AND SYSTEM ORENTED TOWARD SUBWAY PASSENGERS

(71) Applicant: SHENZHEN INSTITUTES OF ADVANCED TECHNOLOGY CHINESE ACADEMY OF SCIENCES, SHENZHEN (CN)

(72) Inventors: LING YIN, SHENZHEN (CN); FAN ZHANG, SHENZHEN (CN); KANG LIU, SHENZHEN (CN)

(21) Appl. No.: 17/507,729

(22) Filed: Oct. 21, 2021

Related U.S. Application Data
(63) Continuation of application No. PCT/CN2019/126260, filed on Dec. 18, 2019.

(30) Foreign Application Priority Data
Apr. 23, 2019 (CN) 201910329331.2

(51) Int. Cl. G06Q 50/00; G06Q 50/26; G06Q 10/06; G06Q 30/02; G06F 16/2455; B61L 15/00

(52) U.S. Cl. CPC G06Q 50/01; G06Q 50/26; B61L 15/0018; G06Q 30/0201; G06F 16/24558; G06Q 10/06312

(57) ABSTRACT

A friend recommendation method oriented towards subway passengers is disclosed, including: obtaining the source data associated with subway station passengers and subway operation; preprocessing the obtained source data; estimating passenger travel paths according to the preprocessed source data; calculating a detailed train operation timetable based on the subway train timetable and train departure intervals; matching each passenger to a specific train based on the estimated passenger travel paths and calculated train operation timetable; and extracting and measuring the interactions between passengers based on the matched passengers and specific trains, and accordingly making a friend recommendation. A friend recommendation system oriented towards subway passengers is further disclosed.

### CROSS-REFERENCE TO RELATED APPLICATIONS

This application is a U.S. continuation of co-pending International Patent Application Number PCT/CN2019/126260, filed Dec. 18, 2019, which claims the benefit and priority of Chinese Patent Application Number 201910329331.2, filed Apr. 23, 2019, before China. National Intellectual Property Administration, the disclosures of which are incorporated herein by reference in their entireties.

### TECHNICAL FIELD

This disclosure relates to a friend recommendation method and system oriented towards subway passengers.

### BACKGROUND

The urban public transportation system (including the bus system and the subway systems is a closed space where a large number of people gather, making it very prone to interaction between passengers, and there are a large number of “familiar strangers” among the passengers. Studying the internal interaction of the public transportation system helps to find passengers with common travel characteristics, dig out the commonalities of social attributes and behavioral preferences in them, thereby improving the recommendation effects of mobile social software.

Existing research on passenger interaction within the urban public transportation system is mainly concentrated in the bus system, and the subway system has not been fully studied. Compared with the bus system, the subway system is larger and more complex, and there are many challenges in extracting passenger interactions in the subway system. For example, there is no record of transfers and getting on/off trains, making it difficult to judge the specific ride behavior of passengers in the subway system.

Existing friend recommendation technology may have the following disadvantages.

First of all, the current friend recommendation by mobile social software is mainly based on the similarity of user registration information, interests, or preferences, or based on the similarity of positioning distance, and there are few friend recommendations based on temporal and spatial interaction.

Next, there are a large number of “familiar strangers” in the urban public transportation system. Through the interactions between passengers, the similarities of their social attributes and behavioral preferences can be further mined, so as to improve the friend recommendation effects by mobile social software. The current research focuses on the bus system, and there is a lack of research on passenger interactions within the subway system.

Finally, subway card-swipe data has the characteristics of large data volume, wide coverage, and refinement, which is suitable for the study of subway passenger behavior. However, the subway card-swipe data only has records related to passengers entering and exiting stations, and lacks the portrayal of passenger behavior in the subway system, such as where the transfer happens, which train the passenger rides, etc. These are necessary to gauge the interactions between passengers and make friend recommendations. The existing passenger-to-train matching algorithm directly estimates the corresponding train that the passenger rides based on the passenger's card swiping times while entering and exiting the particular station, and the result may contain a certain deviation and so is not accurate enough.

Therefore, how to estimate the travel behavior of passengers in the subway system, measure their interactions in the subway spaces, and make friend recommendations based thereon has become a problem that needs to be urgently solved.

### SUMMARY

In view of this, there is a need to provide a friend recommendation method and system oriented towards subway passengers.

The present disclosure provides a friend recommendation method oriented towards subway passengers, including the following operations: a) obtaining the source data of subway station passengers and subway operation; b) preprocessing the obtained source data; c) estimating passenger travel paths according to the preprocessed source data; d) calculating a detailed train operation timetable based on subway train timetables and train departure intervals; e) matching a passenger to a. specific train based on the estimated passenger travel paths and calculated train operation timetable; and f) extracting and measuring the interaction between passengers based on the matched passengers and specific trains, and thereby making a friend recommendation.

The operation b) may include:

processing the original subway card-swipe data;

obtaining complete travel OD data based on the original subway card-swipe data that has been processed above;

performing abnormal OD data cleaning on the obtained complete travel OD data.

The operation c) may include: in conjunction with a subway route map, using Dijkstra algorithm and taking the shortest time as the condition to obtain the optimal travel path for each of all sets of the OD data in the subway space.

The operation e) may include:

e1) clustering the passengers' exit-station. card swipe timestamps, and calculating the passengers' enter-to-exit-station walking time in each station;

e2) calculating the get-off-train timestamp according to the exit-station card swipe timestamp, and matching a non-transfer passenger to a specific train;

e3) calculating the get-on-train time stamp before the transfer based on the enter-station card swipe timestamp, and matching a single-transfer passenger to a. specific train;

e4) calculating the transfer time at the transfer station based on the difference between the departure timestamp of the post-transfer train and the arrival timestamp of the pre-transfer train; and

e5) estimating the first and last rains the passenger rides through operation e3) and taking into account the transfer time at the transfer station, and matching a multiple-transfer passenger to a specific train.

The operation f) may include:

f1) dividing the space of the subway system, obtaining the timestamp of each passenger staying in each space, and determining whether there is interaction between two passengers;

f2) using different tags to name all spaces;

f3) for every two passengers, calculating the average interaction frequency and average interaction duration between the two passengers; and

f4) analyzing the average interaction frequency and average interaction time between a passenger and another passenger that are present in the same subway space, and making a friend recommendation with mobile social software for passengers with an average interaction frequency higher than a first predetermined value and an average interaction time higher than a second predetermined value.

The present disclosure further provides a friend recommendation system oriented towards subway passengers. The friend recommendation system includes an acquisition module, a preprocessing module, an estimation module, a calculation module, a matching module, and a recommendation module. The acquisition module is configured for obtaining the source data of subway station passengers and subway operation. The preprocessing module is configured for preprocessing the obtained source data. The estimation module is configured for estimating passenger travel paths according to the preprocessed source data. The calculation module is configured for calculating a detailed train operation timetable based on subway train timetables and train departure intervals. The matching module is configured for matching a passenger to a specific train based on the estimated passenger travel paths and calculated train operation timetable. The recommendation module is configured for extracting and measuring the interaction between passengers based on the matched passengers and specific trains, and thereby making a friend recommendation.

The preprocessing module may specifically be configured for:

processing the original subway card-swipe data;

obtaining complete travel OD data based on the original subway card-swipe data that has been processed above; and

performing abnormal OD data cleaning on the obtained complete travel OD data.

The estimation module may specifically be configured for: in conjunction with a subway route map, using Dijkstra algorithm and taking the shortest time as the condition to obtain the optimal travel path for each of all sets of the OD data in the subway space.

The matching module may specifically be configured for:

clustering the passengers' exit-station card swipe timestamps, and calculating the passengers' enter-to-exit-station walking time in each station;

calculating the get-off-train timestamp according to the exit-station card swipe timestamp, and matching a non-transfer passenger to a specific train;

calculating the get-on-train time stamp before the transfer based on the enter-station card swipe timestamp, and matching a single-transfer passenger to a specific train;

calculating the transfer time at the transfer station based on the difference between the departure timestamp of the post-transfer train and the arrival timestamp of the pre-transfer train; and

estimating the first and last trains the passenger rides and taking into account the transfer time at the transfer station, and matching a multiple-transfer passenger to a specific train.

The recommendation module may specifically be configured for:

dividing the space of the subway system, obtaining the timestamp of each passenger staving in each space, and determining whether there is interaction between two passengers;

using different tags to name all spaces;

for every two passengers, calculating the average interaction frequency and average interaction duration between the two passengers; and

analyzing the average interaction frequency and average interaction time between a passenger and another passenger that are present in the same subway space, and making a friend recommendation with mobile social software for passengers with an average interaction frequency higher than a first predetermined value and an average interaction time longer than a second predetermined value.

This application provides a friend recommendation method and system oriented towards subway passengers, which extend the social software friend recommendation originally based on user attributes or static spaces to dynamic spaces, and proposes a more accurate method for matching passengers and trains. The existing method of matching passengers and trains consists in estimating the corresponding trains they take directly based on the passenger's entering-station and exit-station card swipe times. In comparison thereto, the passenger and train matching algorithm proposed in this application first divides the passenger's travel path on a spatial and temporal basis. Further, on the basis of obtaining the walking time of each station and the transfer time between different lines of the transfer station, and in conjunction with the train operation timetable data, the passengers are matched with. the corresponding trains they take, which is more accurate in theory. The method for measuring the average interaction frequency and average interaction duration of subway passengers in this application includes not only train space, but also entry and exit space as well as transfer space, which can fully quantify the interaction of passengers in the subway system.

### BRIEF DESCRIPTION OF DRAWINGS

FIG. 1 is a flow chart illustrating a friend recommendation method oriented towards subway passengers according to the present disclosure.

FIG. 2 is a schematic diagram illustrating a passenger swiping card to exit the station event.

FIG. 3 is a schematic diagram illustrating matching a passenger to a specific train.

FIG. 4 is a schematic diagram illustrating extracting and measuring the interaction between passengers.

FIG. 5 is a joint distribution diagram of ACF (Average Interaction Frequency) and ACD (Average Interaction Duration).

FIG. 6 is a hardware architecture diagram of a friend recommendation system oriented towards subway passengers according to the present disclosure.

### DETAILED DESCRIPTION OF ILLUSTRATIVE EMBODIMENTS

For a better understanding of the objectives, technical solutions, and advantages of the present application, hereinafter the present application will be described in further detail in connection with the accompanying drawings and some illustrative embodiments. It is to be understood that the specific embodiments described here are intended for the mere purposes of illustrating this application, instead of limiting.

The present disclosure will be described in further detail below in conjunction with the drawings and some specific embodiments.

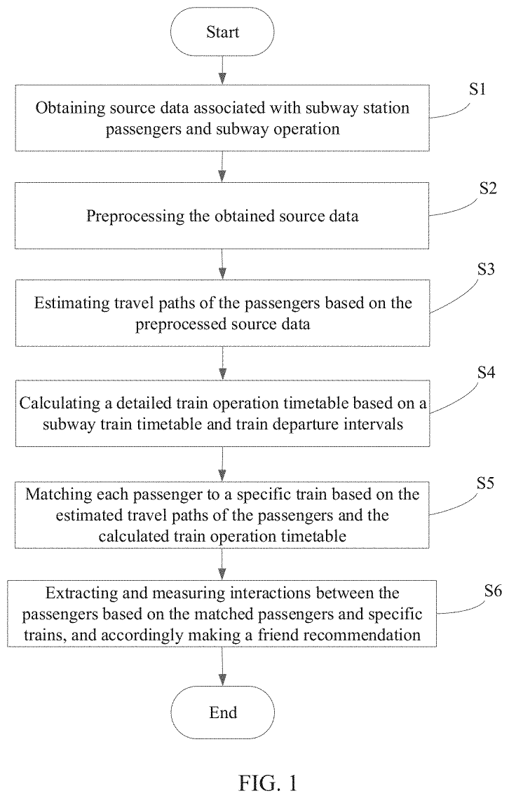

FIG. 1 is an operation flowchart illustrating an exemplary embodiment of a friend recommendation method oriented towards subway passengers according to the present disclosure.

In operation S1, the friend recommendation method includes obtaining the source data associated with subway station passengers and subway operation, The source data may include subway card-swipe data, subway route map, and subway train operation timetable. In particular:

In this embodiment, the source data may include the Shenzhen subway card-swipe data for a total of 20 working days in September 2012, the Shenzhen subway route map in September 2012, and the Shenzhen subway train operation timetables in September 2012. The subway card-swipe data may include card ID, date, timestamp, station name, and type (as shown in Table 1), where the type may include swiping in or out of the station.

TABLE 1

| Card ID | Date | Timestamp | Type | Station Name |
|---|---|---|---|---|
| 330****49 | 20120903 | 08:19:30 | Swipe in | XiLi |
| 360****29 | 20120904 | 09:15:02 | Swipe out | MinLe |
| 700****50 | 20120904 | 11:55:12 | Swipe out | LuoHu |
| 360****92 | 20120905 | 15:53:38 | Swipe in | HuaXin |
| . . . | . . . | . . . | . . . | . . . |

In operation S2, the friend recommendation method includes preprocessing the obtained source data. In particular:

1)Processing the original subway card-swipe data. First, the incomplete fields and abnormal data that are present in the original card-swipe dataset are cleaned out. Then, the original card-swipe data is divided into two parts, namely enter-station card-swipe data and exit station card-swipe data, and the two parts of data are sorted in chronological order, stored in the database and indexed, so as to speed up the matching speed of OD (Origin to Destination) pairs of subsequent travel passengers.

2)Obtaining complete travel OD data based on the original subway card-swipe data that has been processed above Regarding the ID and entering-station time of each subway entering station event, searching for the exit-station event corresponding to this ID that has the smallest difference from the entering-station time, so as to merge them into the complete passenger OD data (as illustrated in Table 2).

3) Performing abnormal OD data cleaning on the obtained complete travel OD data, including deleting the record in which the entered station and the exited station are the same, for which part the travel path would not be able to be estimated.

TABLE 2

| | | Entered | Entering | Exited | Exiting |
|---|---|---|---|---|---|
| Card ID | Date | Station | Timestamp | Station | Timestamp |
| 330****49 | 20120903 | XiLi | 08:19:30 | XinXiu | 08:39:21 |
| 360****29 | 20120904 | Airport East | 08:45:08 | MinLe | 09:15:02 |
| 700****50 | 20120904 | FuMin | 11:32:47 | LuoHu | 11:55:12 |
| 360****92 | 20120905 | HuaXin | 15:53:38 | XiXiang | 16:23:22 |
| . . . | . . . | . . . | . . . | . . . | . . . |

In operation S3, the friend recommendation method includes estimating the travel path of the passenger based on the preprocessed source data. In particular:

For all the sets of OD data, in conjunction with the subway route map, the Dijkstra algorithm is used and the shortest time is taken as the condition to obtain the optimal travel path of all the sets of OD data in the subway space, and the passenger travel behavior is divided into three categories: non-transfer travel, single-transfer travel, and multiple-transfer travel.

In operation S4, the friend recommendation method includes calculating a detailed train operation timetable based on the subway train timetable and the train departure intervals. In particular:

According to the timetables of the first and last trains published from the Metro Group Corporation and the train departure intervals of each subway line (as illustrated in Table 3), the train arrival and departure times at each station are calculated.

TABLE 3

| | Toward LuoHu | | Toward Airport East | | Departure Interval | |
|---|---|---|---|---|---|---|
| | First | Last | First | Last | Peak | Non-Peak |
| Station | Shift | Shift | Shift | Shift | Hours | Hours |
| LuoHu | — | — | 6:30 | 23:00 | 4 min | 6 min |
| GuoMao | 6:55 | 00:06 | 6:32 | 23:02 | 4 min | 6 min |
| LaoJie | 6:53 | 00:04 | 6:33 | 23:03 | 4 min | 6 min |
| . . . | . . . | . . . | . . . | . . . | . . . | . . . |
| HouRui | 6:33 | 23:03 | 06:51 | 00:04 | 4 min | 6 min |
| Airport | 6:30 | 23:00 | — | — | 4 min | 6 min |
| East | | | | | | |

In operation S5, the friend recommendation method includes match a passenger to a specific train based on the estimated passenger travel path and the calculated train operation timetable. Operation S5 may specifically include the following.

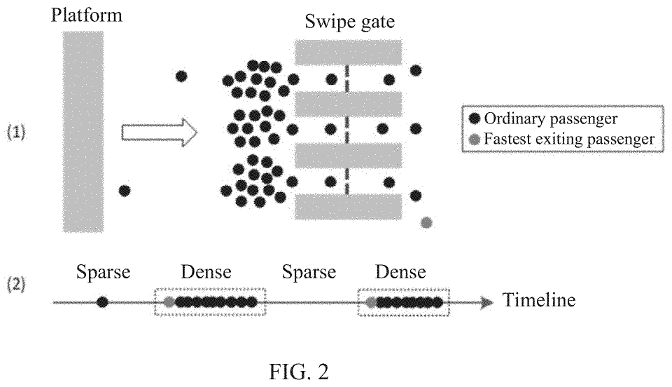

In S501, the operation includes calculating the passengers' enter-to-exit-station walking time in each station. As illustrated in FIG. 2(1), when the train M arrives, passengers get off the train and walk from the platform to the swiping gate, making the swipe card to exit the station events in the timeline relatively frequent (as illustrated in FIG. 2(2)). Among the passengers, the first passenger who swipes the card to exit the station doesn't wait before the swiping gate or stay in the station, so the walking time of this passenger from the platform to the swiping gate can represent the entering-to-exiting station walking time of this station.

In particular, the DBSCAN clustering algorithm may be used to cluster the passenger exit-station card swiping timestamps. Each cluster corresponds to the arrival of a specific train, and the walking time of a station is the difference between the earliest exit-station card swiping timestamp in the cluster and the arrival timestamp of the nearest train before that (obtained from operation S4). Because one entering-to-exiting station walking time can be calculated for each train and there are multiple trains in a day, multiple entering-to-exiting station walking times can be obtained for each station. The box plot method is used to eliminate the outliers in the obtained data, and the minimum value is used as the walking time of the station. In this embodiment, the outliers are defined as values less than QL-1.5IQR or greater than QU+1.5IQR. QL is called the lower quartile, meaning that a quarter of the data in all observations has a smaller value than it. QU is called the upper quartile, meaning that a quarter of the data in all observations has a larger value than it. IQR is called the inter quartile range, meaning the difference between the upper quartile QU and the lower quartile QL.

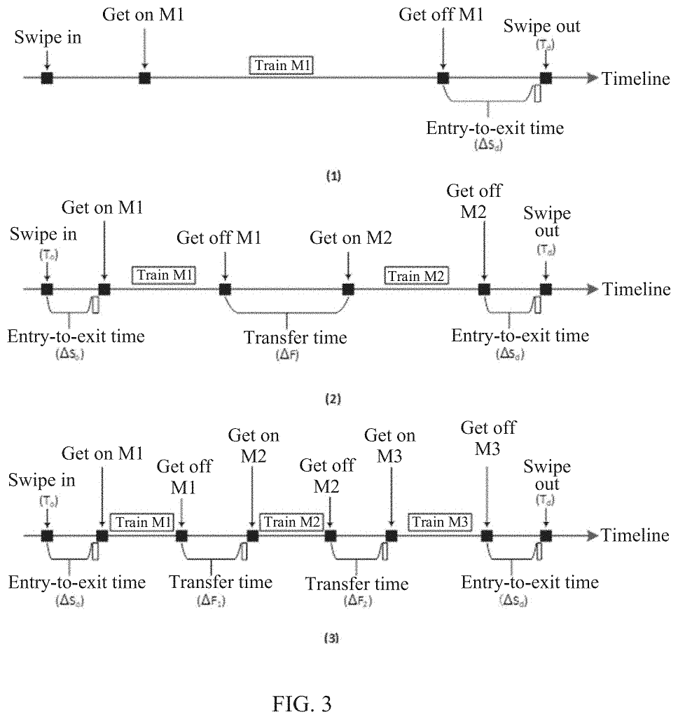

In S502, the operation includes matching a non-transfer passenger to a specific train. The get-off-train timestamp is calculated by subtracting the entering-to-exiting station walking time of the exited station from the exit-station card swiping timestamp (i.e. ,Td-ΔSd), and the train that has arrived earlier at the station most recently is taken as its matching train (as illustrated in FIG. 3(1)). In this way, all non-transfer passengers can each be matched to a specific train.

In S503, the operation includes matching a single-transfer passenger to a specific train. The method of step S502 is used to match the post-transfer train (i.e., train M2). The boarding-train timestamp before the transfer is calculated by subtracting the entering-to-exiting station walking time of the entered station from the entering-station card swiping timestamp (i.e., To+ΔSo), and the most recently arrived train thereafter (i.e., train M1) is taken as the train before the transfer or the pre-transfer train (as illustrated in FIG. 3(2)). In this way, all single-transfer passengers can each be matched to a specific train.

In S502, the operation includes calculating the transfer time of the transfer station. Based on the difference between the departure timestamp of the post-transfer train and the arrival timestamp of the pre-transfer train, the transfer time (Le., ΔF) at the station from the platform of one line to the platform of another line can be estimated. Similarly, multiple values of the transfer time can be obtained. After the abnormal values are eliminated by the box plot method, the minimum value is used as the transfer time from one line to another at the transfer station.

In S505, the operation includes matching a multiple-transfer passenger to a specific train. Taking two transfers as an example, the method in step S503 may be used to estimate the first and last trains (i.e., M1 and M3) the passenger rides. Taking into account the transfer times at the transfer stations 1 and 2 (i.e., ΔF1 and ΔF2), it is considered that the train that departs after the transfer at transfer station 1 and arrives before the transfer at transfer station 2 is the intermediate train (i.e., M2) taken by the passenger (As illustrated in FIG. 3(3)). In this way, all multiple-transfer passengers can each be matched to a specific train.

In operation S6, the friend recommendation method includes extracting and measuring the interaction between passengers based on the matched passengers and specific trains, and making friend recommendation. Operation S6 may specifically include the following.

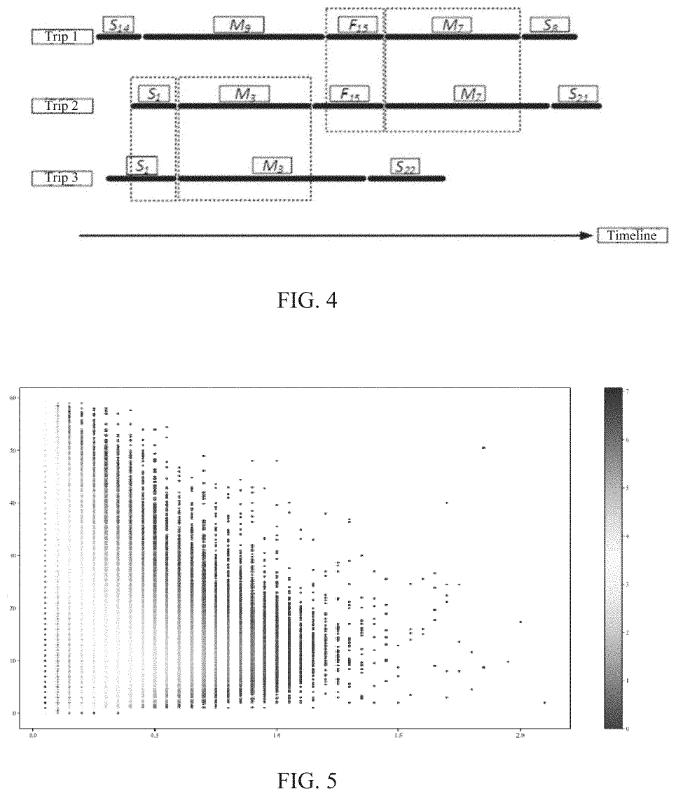

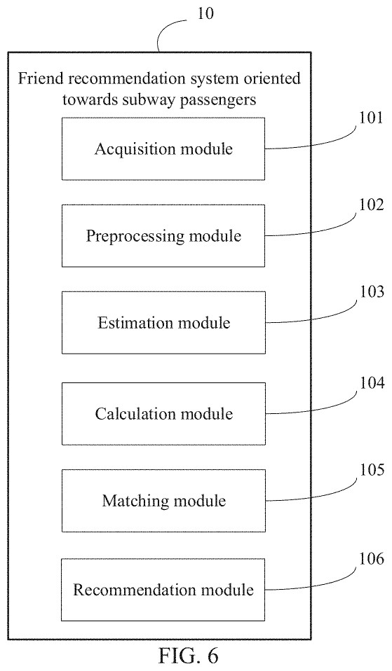

In S601, the operation includes dividing the subway system into three types of spaces, namely, entry and exit space, transfer space, and train space. Taking FIG. 4 as an example, after segmenting the subway system, the timestamp of each passenger staying in each space is obtained, and the timestamp is represented in the time line. In this embodiment, trips 1 and 2 share transfer space F15 and train space M7, trips 2 and 3 share entry and exit space S1 and train space M3. The time during which two passengers are present simultaneously in the same space is defined as the duration of the interaction between the two passengers. If the duration of interaction between two passengers is equal to zero, then the two passengers do not appear simultaneously in time and space; otherwise, the two passengers are deemed to have interacted.

In S602, the operation includes naming all the spaces with different tags. In this embodiment, Si represents the entry and exit space of the subway station, Fj_l1_l2 represents the transfer space of line 1 to line 2 at the transfer station j, and Mk represents the train space of train k.

In S603, the operation includes summing the time periods in which two passengers appear simultaneously in the same spaces as the duration of interaction between the two passengers. This embodiment defines two metrics: ACF (Average Interaction Frequency) and ACD (Average Interaction Duration), which are used to measure the interaction between passengers and in the course of multiple days.

$$\begin{matrix}{ACF}_{i , j} = \frac{F}{D} & ( 1 ) \\ {ACD}_{i , j} = \frac{{\sum }_{f = 1}^{F} Δ {t}_{f}}{F} & ( 2 )\end{matrix}$$

where D denotes the number of days, F denotes the number of interactions in D days, Δtf is the duration of the f-th interaction and Σ_{f=1}^{F}Δt_{f} is the total interaction time in days.

In S604, the operation includes analyzing the average interaction frequency and average interaction time between a passenger and another passenger that are present in the same subway spaces, and finding a pair of passengers with an average interaction frequency higher than a first predetermined value and an average interaction duration longer than a second predetermined value, and making a friend recommendation with mobile social software for the above passengers with high average interaction frequency and long average interaction time that are respectively higher and longer than the first and second predetermined values.

In this embodiment, as illustrated in FIG. 5, the horizontal axis x represents the ACF of the passenger pair, the vertical axis y represents the ACD of the passenger pair (unit: minute), and the color of the solid dots in the coordinate system represents the logarithm of the number of passenger pairs. In FIG. 5, it can be found that the distribution of ACF and ACD presents a certain pattern. Passenger pairs are concentrated in the triangle at the left bottom of the figure, which conveys two important messages. First, most passenger pairs have a short average interaction time and a low average interaction frequency. Secondly, in the case of the same ACD, the number of passenger pairs decreases with the increase of ACF, indicating that the average interaction time of infrequently encountered passengers varies within a relatively wide range (from 0 to 60 minutes), while the average interaction time of frequently encountered passengers varies within a relatively small range and has a relatively small value. From this figure, we can clearly find those passenger pairs with an average interaction frequency higher than a first predetermined value and an average interaction time longer than a second predetermined value. For example, if the ACD is set to be greater than or equal to 20 minutes and the ACF is set greater than or equal to 1.5, friend recommendations can be made with mobile social software for such passenger pairs.

FIG. 2 is a hardware architecture diagram of a friend recommendation system 10 oriented towards subway passengers according to the present disclosure. The friend recommendation system includes an acquisition module 101, a preprocessing module 102, an estimation module 103, a calculation module 104, a matching module 105, and a recommendation module 106.

The acquisition module 101 is configured for obtaining the source data associated with subway station passengers and subway operation. The source data may include subway card-swipe data, subway route map, and subway train operation timetable. In particular:

In this embodiment, the source data may include the Shenzhen subway card-swipe data for a total of 20 working days in September 2012, the Shenzhen subway route map in September 2012, and the Shenzhen subway train operation timetables in September 2012. The subway card-swipe data may include card ID, date, timestamp, station name, and type (as shown in Table 1), where the type may include swiping in or out of the station.

TABLE 1

| Card ID | Date | Timestamp | Type | Station Name |
|---|---|---|---|---|
| 330****49 | 20120903 | 08:19:30 | Swipe in | XiLi |
| 360****29 | 20120904 | 09:15:02 | Swipe out | MinLe |
| 700****50 | 20120904 | 11:55:12 | Swipe out | LuoHu |
| 360****92 | 20120905 | 15:53:38 | Swipe in | HuaXin |
| . . . | . . . | . . . | . . . | . . . |

The preprocessing module 102 is configured for preprocessing the obtained source data. The above operation may specifically include the following.

The preprocessing module 102 is configured for processing the original subway card-swipe data. First, the incomplete fields and abnormal data that are present in the original card-swipe data set are cleaned out. Then, the original card-swipe data is divided into two parts, namely enter-station card-swipe data and exit station card-swipe data, and the two parts of data are sorted in chronological order, stored in the database and indexed, so as to speed up the matching speed of OD pairs of subsequent travel passengers.

The preprocessing module 102 is configured for obtaining complete travel OD data based on the original subway card-swipe data that has been processed above. Regarding the ID and entering-station time of each subway entering station event, search for the exit-station event corresponding to this ID that has the smallest difference from the entering-station time, so as to merge them into the complete passenger OD data (as illustrated in Table 2).

The preprocessing module 102 is further configured for performing abnormal OD data cleaning on the obtained complete travel OD data, including deleting the record in which the entered station and the exited station are the same, for which part the travel path would not be able to be estimated.

TABLE 2

| | | Entered | Entering | Exited | Exiting |
|---|---|---|---|---|---|
| Card ID | Date | Station | Timestamp | Station | Timestamp |
| 330****49 | 20120903 | XiLi | 08:19:30 | XinXiu | 08:39:21 |
| 360****29 | 20120904 | Airport East | 08:45:08 | MinLe | 09:15:02 |
| 700****50 | 20120904 | FuMin | 11:32:47 | LuoHu | 11:55:12 |
| 360****92 | 20120905 | HuaXin | 15:53:38 | XiXiang | 16:23:22 |
| . . . | . . . | . . . | . . . | . . . | . . . |

The estimation module 103 is configured for estimating the travel path of the passenger based on the preprocessed source data. In particular:

For all the sets of OD data, in conjunction with the subway route map, the Dijkstra algorithm is used and the shortest time is taken as the condition to obtain the optimal travel path of all the sets of OD data in the subway space, and the passenger travel behavior is divided into three categories: non-transfer travel, single-transfer travel, and multiple-transfer travel.

The calculation module 104 is configured for calculating a detailed train operation timetable based on the subway train timetable and the train departure intervals. In particular:

According to the timetables of the first and last trains published from the Metro Group Corporation and the train departure intervals of each subway line (as illustrated in Table 3), the train arrival and departure times at each station are calculated.

TABLE 3

| | Toward LuoHu | | Toward Airport East | | Departure Interval | |
|---|---|---|---|---|---|---|
| | First | Last | First | Last | Peak | Non-Peak |
| Station | Shift | Shift | Shift | Shift | Hours | Hours |
| LuoHu | — | — | 06:30 | 23:00 | 4 min | 6 min |
| GuoMao | 06:55 | 00:06 | 06:32 | 23:02 | 4 min | 6 min |
| LaoJie | 06:53 | 00:04 | 06:33 | 23:03 | 4 min | 6 min |
| . . . | . . . | . . . | . . . | . . . | . . . | . . . |
| HouRui | 06:33 | 23:03 | 06:51 | 00:04 | 4 min | 6 min |
| Airport | 06:30 | 23:00 | — | — | 4 min | 6 min |
| East | | | | | | |

The matching module 105 is configured for matching a passenger to a specific train based on the estimated passenger travel path and the calculated train operation timetable. The above operation may specifically include the following.

The matching module 105 is configured for calculating the passengers' enter-to-exit-station walking time in each station. As illustrated in FIG. 2(1), when the train M arrives, passengers get off the train and walk from the platform to the swiping gate, making the swipe card to exit the station events in the timeline relatively frequent (as illustrated in FIG. 2(2)), Among the passengers, the first passenger who swipes the card to exit the station doesn't wait before the swiping gate or stay in the station, so the walking time of this passenger from the platform to the swiping gate can represent the entering-to-exiting station walking time of this station.

In particular, the DBSCAN clustering algorithm may be used to cluster the passenger exit-station card swiping timestamps. Each cluster corresponds to the arrival of a specific train, and the walking time of a station is the difference between the earliest exit-station card swiping timestamp in the cluster and the arrival timestamp of the nearest train before that. Because one entering-to-exiting station walking time can be calculated for each train and there are multiple trains in a day, multiple entering-to-exiting station walking times can be obtained for each station. The box plot method is used to eliminate the outliers in the obtained data, and the minimum value is used as the walking time of the station. In this embodiment, the outliers are defined as values less than QL-1.5IQR or greater than QU+1.5QR. QL is called the lower quartile, meaning that a quarter of the data in all observations has a smaller value than it. QU is called the upper quartile, meaning that a quarter of the data in all observations has a larger value than it. IQR is called the inter quartile range, meaning the difference between the upper quartile QU and the lower quartile QL.

The matching module 105 is configured for matching a non-transfer passenger to a specific train. The get-off-train timestamp is calculated by subtracting the entering-to-exiting station walking time of the exited station from the exit-station card swiping timestamp (i.e., Td-ΔSd), and the train that has arrived earlier at the station most recently is taken as its matching train (as illustrated in FIG. 3(1)). In this way, all non-transfer passengers can each be matched to a specific train.

The matching module 105 is configured for matching a single-transfer passenger to a specific train. The post-transfer train (i.e., train M2) is matched. The boarding-train timestamp before the transfer is calculated by subtracting the entering-to-exiting station walking time of the entered station from the entering-station card swiping timestamp (i.e., To+ΔSo), and the most recently arrived train thereafter (i.e., train M1) is taken as the train before the transfer or the pre-transfer train (as illustrated in FIG. 3(2)). In this way, all single-transfer passengers can each be matched to a specific train.

The matching module 105 is configured for calculating the transfer time of the transfer station. Based on the difference between the departure timestamp of the post-transfer train and the arrival timestamp of the pre-transfer train, the transfer time (i.e., ΔF) at the station from the platform of one line to the platform of another line can be estimated. Similarly, multiple values of the transfer time can be obtained. After the abnormal values are eliminated by the box plot method, the minimum value is used as the transfer time from one line to another at the transfer station.

The matching module 105 is configured for matching a multiple-transfer passenger to a specific train. Taking two transfers as an example, the first and last trains (i.e., M1 and M3) the passenger rides are estimated. Taking into account the transfer times at the transfer stations 1 and 2 (i.e., ΔF1 and ΔF2), it is considered that the train that departs after the transfer at transfer station 1 and arrives before the transfer at transfer station 2 is the intermediate train (i.e., M2) taken by the passenger (As illustrated in FIG. 3(3)). In this way, all multiple-transfer passengers can each be matched to a specific train.

The recommendation module 106 is configured for extracting and measuring the interaction between passengers based on the matched passengers and specific trains, and making friend recommendation. The above operation may specifically include the following.

The recommendation module 106 is configured for dividing the subway system into three types of spaces, namely, entry and exit space, transfer space, and train space. Taking FIG. 4 as an example, after segmenting the subway system, the timestamp of each passenger staying in each space is obtained, and the timestamp is represented in the time line. In this embodiment, trips 1 and 2 share transfer space F15 and train space M7, trips 2 and 3 share entry and exit space S1 and train space M3. The time during which two passengers are present simultaneously in the same space is defined as the duration of the interaction between the two passengers. If the duration of interaction between two passengers is equal to zero, then the two passengers do not appear simultaneously in time and space; otherwise, the two passengers are deemed to have interacted.

The recommendation module 106 is configured for naming all the spaces with different tags. In this embodiment, Si represents the entry and exit space of the subway station, Fj_l1_l2 represents the transfer space of line 1 to line 2 at the transfer station j, and Mk represents the train space of train k,

The recommendation module 106 is configured for summing the time periods in which two passengers appear simultaneously in the same spaces as the duration of interaction between the two passengers. This embodiment defines two metrics: ACF (Average Interaction Frequency) and ACD (Average Interaction Duration), which are used to measure the interaction between passengers and in the course of multiple days.

$$\begin{matrix}{ACF}_{i , j} = \frac{F}{D} & ( 1 ) \\ {ACD}_{i , j} = \frac{{\sum }_{f = 1}^{F} Δ {t}_{f}}{F} & ( 2 )\end{matrix}$$

where D denotes the number of days, F denotes the number of interactions in the D days, Δtf is the duration of the f-th interaction and Σ_{f=1}^{F}Δt_{f} is the total interaction time in days.

The recommendation module 106 is configured for analyzing the average interaction frequency and average interaction time between a passenger and another passenger that are present in the same subway space, finding the passenger pairs with high average interaction frequency and long average interaction time that are respectively higher and longer than a first predetermined value and a second predetermined value, and making a friend recommendation with mobile social software for passengers with high average interaction frequency and long average interaction time that are respectively higher and longer than the first and second predetermined values.

In this embodiment, as illustrated in FIG. 5, the horizontal axis x represents the ACF of the passenger pair, the vertical axis y represents the ACD of the passenger pair (unit: minute), and the color of the solid dots in the coordinate system represents the logarithm of the number of passenger pairs. In FIG. 5, it can be found that the distribution of ACF and ACD presents a certain pattern. Passenger pairs are concentrated in the triangle at the left bottom of the figure, which conveys two important messages. First, most passenger pairs have a short average interaction time and a low average interaction frequency. Secondly, in the case of the same ACD, the number of passenger pairs decreases with the increase of ACF, indicating that the average interaction time of infrequently encountered passengers varies within a relatively wide range (from 0 to 60 minutes), while the average interaction time of frequently encountered passengers varies within a relatively small range and has a relatively small value. From this figure, we can clearly find those passenger pairs with high average interaction frequency and long average interaction time. For example, if the ACD is set to be greater than or equal to 20 minutes and the ACF is set greater than or equal to 1.5, friend recommendations can be made with mobile social software for such passenger pairs.

The present disclosure provides a friend recommendation method and system oriented towards subway passengers, which use subway card-swipe data, subway route map, and subway train operation timetable to match subway passengers to specific trains, match passenger travel routes to specific subway spaces, calculate the interaction between passengers based on the matching results, and finally find the related passengers for friend recommendation.

The foregoing merely portrays some illustrative embodiments of the present disclosure. It should be noted that those of ordinary skill in the art will be able to make multiple improvements and modifications without departing from the principle of this disclosure, and these improvements and modifications should all be regarded as falling in the scope of protection of this disclosure.

What is claimed is:

1. A friend recommendation method oriented towards subway passengers, comprising the following operations:
a) obtaining source data associated with subway passengers and subway operation;
b) preprocessing the obtained source data;
c) estimating travel paths of the subway passengers based on the preprocessed source data;
d) calculating a detailed train operation timetable based on a subway train timetable and train departure intervals;
e) matching each of the subway passengers to a specific train based on the estimated travel paths of the subway passengers and the calculated train operation timetable; and
f) extracting and measuring interactions between the subway passengers based on the matched subway passengers and specific trains, and accordingly making a friend recommendation.

2. The method as recited in claim 1, wherein operation b) comprises:
processing original subway card-swipe data;
obtaining complete travel OD (original to destination) data based on the original subway card-swipe data that has been processed above; and
performing abnormal OD data cleaning on the obtained complete travel OD data.

3. The method as recited in claim 2, wherein operation c) comprises:
in conjunction with a subway route map, using Dijkstra. algorithm and taking the shortest time as the condition to obtain an optimal travel path for each of all sets of the OD data in subway space.

4. The method as recited in claim 3, wherein operation e) comprises:
e1) clustering exit-station card swipe timestamps of the subway passengers, and calculating an entry-to-exit walking time of each station;
e2) calculating a get-off-train timestamp based on the exit-station card swipe timestamp, and matching a non-transfer passenger o a specific train;
e3) calculating a get-on-train time stamp before a transfer based on an enter-station card swipe timestamp, and matching a single-transfer passenger to a specific train;
e4) calculating a transfer time at a transfer station based on a difference between a departure timestamp of a post-transfer train and an arrival timestamp of a pre-transfer train; and
e5) estimating the first and last trains each subway passenger rides through operation e3), and matching a multiple-transfer passenger to a specific train taking into account the transfer time at the transfer station.

5. The method as recited in claim 4, wherein operation f) comprises:
f1) dividing a space of the subway system, obtaining a timestamp of each subway passenger staying in each space, and determining whether there is interaction between every two passengers;
f2) using different tags to name all spaces;
f3) for every two subway passengers, calculating an average interaction frequency and average interaction duration there between; and
f4) analyzing the average interaction frequency and average interaction time between a passenger and another passenger that are present in the same subway spaces, and making a friend recommendation with mobile social software for subway passengers with an average interaction frequency higher than a first predetermined value and an average interaction time longer than a second predetermined value.

6. A friend recommendation system oriented towards subway passengers, comprising at least one processor and a non-transitory computer-readable storage medium storing program instructions executable by the at least one processor, wherein the program instructions comprise an acquisition module, a preprocessing module, an estimation module, a calculation module, a matching module, and a recommendation module;
wherein the acquisition module is configured for obtaining source data associated with subway station passengers and subway operation;
the preprocessing module is configured for preprocessing the obtained source data;
the estimation module is configured for estimating travel paths of the subway passengers based on the preprocessed source data;
the calculation module is configured for calculating a detailed train operation timetable: based on a subway train timetable and train departure intervals;
the matching module is configured for matching each of the subway passengers to a specific train based on the estimated travel paths of the subway passengers and the calculated train operation timetable; and
the recommendation module is configured for extracting and measuring interactions between the subway passengers based on the matched subway passengers and specific trains, and according making a friend recommendation.

7. The system as recited in claim 6, wherein the preprocessing module is configured for:
processing original subway card-swipe data;
obtaining complete travel OD (original to destination) data based on the original subway card-swipe data that has been processed above; and
performing abnormal OD data cleaning on the obtained complete travel OD data.

8. The system as recited in claim 7, wherein the estimation module is configured for:
in conjunction with a subway route map, using Dijkstra algorithm and taking the shortest time as the condition to obtain an optimal travel path for each of all sets of the OD data in subway space.

9. The system as recited in claim 8, wherein the matching module is configured for:
clustering exit-station card swipe timestamps of the subway passengers, and calculating an entry-to-exit walking time in each station;
calculating a get-off-train timestamp according to the exit-station card swipe timestamp, and matching a non-transfer passenger to a specific train;
calculating a get-on-train time stamp before a transfer based on an enter-station card swipe timestamp, and matching a single-transfer passenger to a specific train;
calculating a transfer time at a transfer station based on a difference between a departure timestamp of a post-transfer train and an arrival timestamp of a pre-transfer train; and
estimating the first and last trains each subway passenger rides through operation e3), and matching a multiple-transfer passenger to a specific train taking into account the transfer time at the transfer station.

10. The system as recited in claim 9, wherein the recommendation module is configured for:
dividing a space of the subway system, obtaining a timestamp of each subway passenger staying in each space, and determining whether there is interaction between every two passengers;
using different tags to name all spaces;
for every two passengers, calculating an average interaction frequency and average interaction duration there between; and
analyzing the average interaction frequency and average interaction time between a passenger and another passenger that are present in the same subway spaces, and making a friend recommendation with mobile social software for subway passengers with an average interaction frequency higher than a first predetermined value and an average interaction higher a second predetermined value.
